(19) United States
(12) Patent Application Publication
(10) Pub. No.: US 2022/0344750 A1
(43) Pub. Date: Oct. 27, 2022

(54) CYLINDRICAL BATTERY AND METHOD FOR MANUFACTURING THE SAME

(71) Applicant: LG ENERGY SOLUTION, LTD., Seoul (KR)

(72) Inventor: Inbok PARK, Daejeon (KR)

(73) Assignee: LG ENERGY SOLUTION, LTD., Seoul (KR)

(21) Appl. No.: 17/764,911

(22) PCT Filed: Nov. 30, 2020
(86) PCT No.: PCT/KR2020/017326

§ 371 Date: Mar. 29, 2022

(30) Foreign Application Priority Data
Jan. 13, 2020 (KR) 10-2020-0004258

(51) Int. Cl. H01M 50/107; H01M 10/0587; H01M 50/152; H01M 50/179; H01M 50/317; H01M 50/574

(52) U.S. Cl. CPC H01M 50/107; H01M 10/0587; H01M 50/152; H01M 50/179; H01M 50/317; H01M 50/574

(57) ABSTRACT

A cylindrical battery includes a plurality of electrode assemblies, and a plurality of top cap assemblies located on an upper part of the plurality of electrode assemblies. The plurality of top cap assemblies are electrically separated from each other by an insulator.

### TECHNICAL FIELD

### Cross Citation with Related Application(s)

This application claims the benefit of Korean Patent Application No. 10-2020-0004258 filed on Jan. 13, 2020, in the Korean Intellectual Property Office, the disclosure of which is incorporated herein by reference in its entirety.

The present disclosure relates to a cylindrical battery and a method for manufacturing the cylindrical battery.

### BACKGROUND ART

As energy prices are increasing due to the depletion of fossil fuels and increasing attention is being paid to environmental pollution, the demand for environmentally-friendly alternative energy sources acts as an essential factor for future life. Thus, research into techniques for generating various kinds of power, such as nuclear energy, solar energy, wind energy, and tidal power, is underway, and power storage apparatuses for more efficient use of the generated energy are also drawing much attention.

Moreover, the demand for batteries as energy sources is rapidly increasing as mobile device technology continues to develop and the demand for such mobile devices continues to increase. Accordingly, much research on batteries capable of satisfying various needs has been carried out. In particular, in terms of the material for batteries, the demand for lithium secondary batteries, such as lithium ion batteries and lithium ion polymer batteries, which have advantages such as high energy density, discharge voltage, and output stability, is very high.

Secondary batteries may be classified based on the structure of an electrode assembly having a structure in which a positive electrode and a negative electrode are stacked in the state in which a separator is interposed between the positive electrode and the negative electrode. For example, the electrode assembly may be configured to have a jelly-roll (wound) type structure in which a long sheet type positive electrode and a long sheet type negative electrode are wound with a separator being interposed between the positive electrode and the negative electrode or a stacked (laminated) type structure in which pluralities of positive electrodes and negative electrodes, cut into predetermined unit sizes, are sequentially stacked with separators being interposed between the positive electrodes and the negative electrodes. In recent years, in order to solve problems caused by the jelly-roll type electrode assembly and the stacked type electrode assembly, there has been developed a stacked/folded type electrode assembly, which is a combination of the jelly roll type electrode assembly and the stacked type electrode assembly, having an improved structure in which predetermined numbers of positive electrodes and negative electrodes are sequentially stacked in the state in which separators are disposed respectively between the positive electrodes and the negative electrodes to constitute a unit cell, after which a plurality of unit cells is sequentially folded in the state of having been placed on a separation film.

These electrode assemblies are mounted in a pouch case, a cylindrical can, a prismatic case, and the like depending on the purpose of use to produce a battery.

Among them, the cylindrical battery has the advantages of being easy to manufacture and having a high energy density per weight, and thus, is used as an energy source for various devices ranging from portable computers to electric vehicles.

FIG. 1 is a schematic diagram showing a conventional cylindrical battery.

Referring to FIG. 1, the cylindrical battery 100 is manufactured by housing a jelly-roll type electrode assembly 120 in a cylindrical case 130, injecting an electrolyte solution in the cylindrical case 130, and coupling a top cap 140 to an opened upper end of the cylindrical case 130.

The jelly-roll type electrode assembly 120 has a structure, in which a positive electrode 121, a separator 122 and a negative electrode 123 are stacked in a sequence to be wound in a round shape, and a cylindrical center pin 150 is inserted into a central part of the electrode assembly 120, which is a mandrel thereof. The center pin 150 functions to fix and support the electrode assembly 120, and also functions as a passage for discharging gas generated by internal reactions at the time of charging/discharging and operation. However, the center pin 150 may not be used depending on the specifications of the cylindrical battery 100.

In the charging/discharging process of the cylindrical battery 100, the electrodes of the electrode assembly 120 are repeatedly expanded and contracted. Therefore, structural deformation occurs in which the electrode assembly 120 is distorted. In particular, the deformation occurs more severely in the central part of the electrode assembly 120 where stress is concentrated.

In addition, the cylindrical battery 100 generates high thermal energy inside the cylindrical battery 100 in the charging/discharging process. However, the conventional cylindrical battery 100 does not have a system capable of rapidly discharging the thermal energy. In particular, recently, the demand for a cylindrical battery capable of high capacity and high output is increasing. Accordingly, when an electrode highly loaded with an active material is used, there is a problem that runaway may occur.

### DETAILED DESCRIPTION OF THE INVENTION

### Technical Problem

It is an object of the present disclosure to provide a cylindrical battery that can prevent deformation and runaway of the electrode assembly, and a method for manufacturing the cylindrical battery.

However, the objects of embodiments of the present disclosure are not limited to the aforementioned objects, and can be variously expanded within the scope of the technical idea included in the present disclosure.

### Technical Solution

According to one embodiment of the present disclosure, there can be provided a cylindrical battery comprising a plurality of electrode assemblies, and a plurality of top cap assemblies located on an upper part of the plurality of electrode assemblies, wherein the plurality of top cap assemblies are electrically separated from each other by an insulator.

The plurality of top cap assemblies may include a first top cap assembly having a first upper end cap, a first current interruptive device, and a first gas storage, and a second top cap assembly having a second upper end cap, a second current interruptive device, and a second gas storage.

The insulator may include an upper insulator and a lower insulator.

The upper insulator may have a “Π”-shaped cross-sectional shape.

The upper insulator may receive an intermediate part of the lower insulator.

The lower insulator may be located between the first current interruptive device and the second current interruptive device, and may electrically insulate the first current interruptive device and the second current interruptive device.

The upper insulator may be attached to the first current interruptive device and the second current interruptive device.

If any one of the first current interruptive device or the second current interruptive device is operated, the upper insulator may move upward and protrude beyond the plurality of top cap assemblies.

When the first current interruptive device or the second current interruptive device is operated, gas generated in the electrode assembly may be collected in the first gas storage and the second gas storage.

When the upper insulator moves upward a predetermined height or higher due to the pressure of the gas collected in the first gas storage unit and the second gas storage unit, the gas collected in the first gas storage unit and the second gas storage unit may be discharged to outside the plurality of top cap assemblies.

The insulator may include a first insulator, a second insulator, and a lower insulator.

The first insulator and the second insulator may be independent of each other.

The first insulator is attached to the first current interruptive device, and when the first current interruptive device is operated, the first insulator may move upward and protrude beyond the plurality of top cap assemblies.

The second insulator is attached to the second current interruptive device, and when the second current interruptive device is operated, the second insulator may move upward and protrude beyond the plurality of top cap assemblies.

The plurality of electrode assemblies includes a first electrode assembly and a second electrode assembly, and the first electrode assembly may be located in a central part of the second electrode assembly.

A first positive electrode tab of the first electrode assembly may be electrically connected to the first top cap assembly, and a second positive electrode tab of the second electrode assembly may be electrically connected to the second top cap assembly.

According to another embodiment of the present disclosure, there is provided a method for manufacturing a cylindrical battery comprising the steps of: winding a first positive electrode, a first separator, and a first negative electrode to manufacture a first electrode assembly having a central part; winding a second positive electrode, a second separator, and a second negative electrode to manufacture a second electrode assembly; inserting the first electrode assembly into the central part of the second electrode assembly; electrically connecting a first positive electrode tab of the first electrode assembly to a first top cap assembly; and electrically connecting a second positive electrode tab of the second electrode assembly to a second top cap assembly.

According to yet another embodiment of the present disclosure, there is provided a method for manufacturing a cylindrical battery comprising the steps of: winding a first positive electrode, a first separator, and a first negative electrode to manufacture a first electrode assembly; winding a stack of a second positive electrode, a second separator, and a second negative electrode using the first electrode assembly as a mandrel to manufacture a second electrode assembly such that the first electrode assembly in located in a central part of the second electrode assemble; electrically connecting a first positive electrode tab of the first electrode assembly to a first top cap assembly; and electrically connecting a second positive electrode tab of the second electrode assembly to a second top cap assembly.

### Advantageous Effects

As described above, the cylindrical battery according to the embodiment of the present disclosure can prevent the cylindrical battery from being damaged or deformed by using electrically separated top cap assemblies.

### BRIEF DESCRIPTION OF THE DRAWINGS

FIG. 1 is a schematic view showing a conventional cylindrical battery.

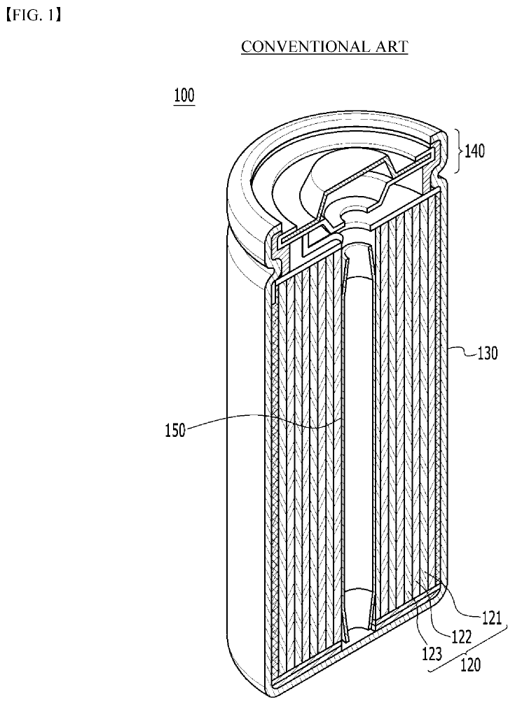

FIG. 2 is a schematic view of a cylindrical battery according to an embodiment of the present disclosure.

FIG. 3 is a schematic cross-sectional view of the top cap assembly taken along the line A-A′ in FIG. 2.

FIG. 4 is a schematic view showing a state in which the upper insulator of FIG. 3 is protruded upward.

FIG. 5 is a schematic view showing the insulator of FIG. 2.

FIG. 6 is a schematic cross-sectional view showing a top cap assembly according to another embodiment of the present disclosure.

FIG. 7 is a schematic cross-sectional view showing a top cap assembly according to another embodiment of the present disclosure.

FIG. 8 is a schematic view showing that the electrode assembly of FIG. 2 is manufactured according to an embodiment of the present disclosure.

FIG. 9 is a schematic diagram showing that the electrode assembly of FIG. 2 is manufactured according to another embodiment of the present disclosure.

### DETAILED DESCRIPTION OF THE EMBODIMENTS

Hereinafter, various embodiments of the present disclosure will be described in detail with reference to the accompanying drawings so that those skilled in the art can easily carry out them. The present disclosure may be modified in various different ways, and is not limited to the embodiments set forth herein.

Further, throughout the specification, when a portion is referred to as “including” a certain component, it means that the portion can further include other components, without excluding the other components, unless otherwise stated.

Further, throughout the specification, “upward” means the direction opposite to the gravity acting direction.

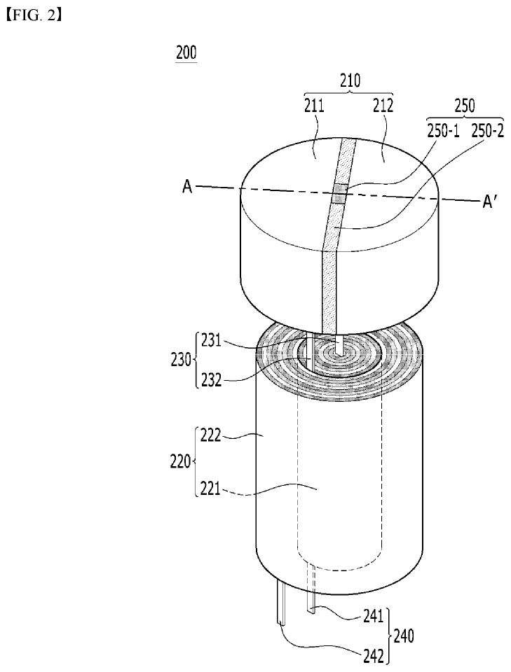

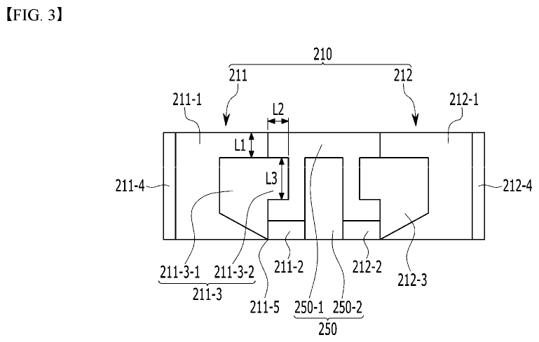

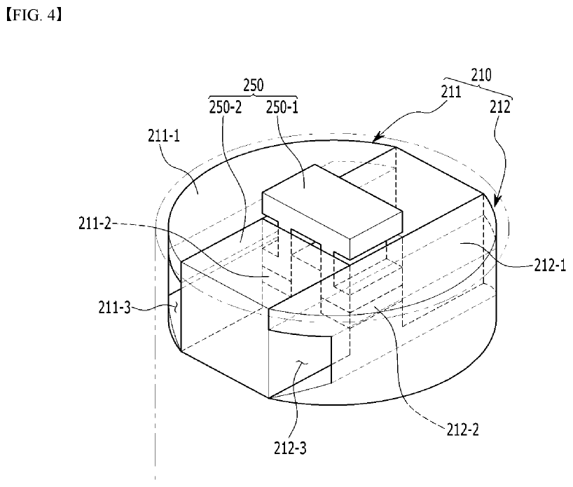

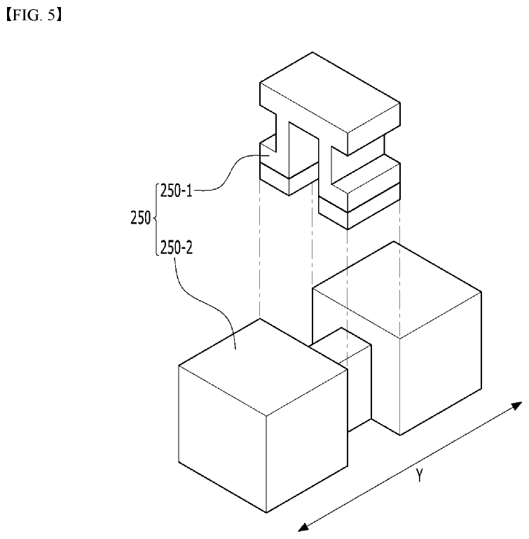

FIG. 2 is a schematic view of a cylindrical battery according to an embodiment of the present disclosure. FIG. 3 is a schematic cross-sectional view of the top cap assembly taken along the line A-A′ in FIG. 2. FIG. 4 is a schematic view showing a state in which the upper insulator of FIG. 3 was protruded upward. FIG. 5 is a schematic view showing the insulator of FIG. 2.

Referring to FIGS. 2 to 5, the cylindrical battery 200 may be a structure in which a jelly-roll type electrode assembly 220 is inserted into a battery case (not shown). A positive electrode tab 230 can be formed in the upper part of the electrode assembly 220 to be electrically connected to a top cap assembly 210. A negative electrode tab 240 can be formed in the lower part of the electrode assembly 220 to be electrically connected to the battery case. The positive electrode tab 230 may include a first positive electrode tab 231 and a second positive electrode tab 232. The negative electrode tab 240 may include a first negative electrode tab 241 and a second negative electrode tab 242.

The top cap assembly 210 may include a first top cap assembly 211 and a second top cap assembly 212. The first top cap assembly 211 and the second top cap assembly 212 may be electrically separated by the insulator 250. The first top cap assembly 211 and the second top cap assembly 212 may be structured so as to be mutually symmetrical with respect to the insulator 250.

The first positive electrode tab 231 may be electrically connected to the second top cap assembly 212. The second positive electrode tab 232 may be electrically connected to the first top cap assembly 211.

The insulator 250 may be formed in a structure extending in the length and width directions of the top cap assembly 210 while passing through the central part of the top cap assembly 210. The insulator 250 may include an upper insulator 250-1 and a lower insulator 250-2.

The first top cap assembly 211 may include a first upper end cap 211-1, a first current interruptive device 211-2, a first gas storage unit 211-3, and a gasket 211-4. The first upper end cap 211-1 may form a positive electrode terminal in a form of being exposed to the outside. The first current interruptive device 211-2 may be formed in the lower part of the upper insulator 250-1.

The second top cap assembly 212 includes a second upper end cap 212-1, a second current interruptive device 212-2, a second gas storage unit 212-3, and a second gasket 212-4. The second upper cap 212-1 may form a positive electrode terminal in a form of being exposed to the outside of the cylindrical battery 200. The second current interruptive device 212-2 may be formed in the lower part of the upper insulator 250-1.

The upper insulator 250-1 may be structured so as to be attached to the first current interruptive device 211-2 and the second current interruptive device 212-2. Thus, even if any one of the first current interruptive device 211-2 and the second current interruptive device 212-2 is operated, the upper insulator 250-1 may move upward and protrude to the outside.

For example, when the first current interruptive device 211-2 is operated, the upper insulator 250-1 moves upward, and the second current interruptive device 212-2 attached to the upper insulator 250-1 can also move upward together. In addition, when the second current interruptive device 212-2 is operated, the upper insulator 250-1 moves upward, and the first current interruptive device 211-2 attached to the upper insulator 250-1 can also move upwards together.

Further, when the upper insulator 250-1 moves upward and protrudes to the outside, the operator can visually confirm the degree of protrusion of the upper insulator 250-1. And, the degree of generation of the internal gas can be grasped through the degree of protrusion of the upper insulator 250-1.

The upper insulator 250-1 may have a “Π” shaped cross section cut along the line A-A′. The upper insulator 250-1 may be formed at an intermediate part in the length direction Y of the lower insulator 250-2. The upper insulator 250-1 may be coupled in a structure that wraps the intermediate part of the lower insulator 250-2.

The lower insulator 250-2 may be located between the first current interruptive device 211-2 and the second current interruptive device 212-2. The first current interruptive device 211-2 and the second current interruptive device 212-2 may be structured to be electrically insulated from each other by the lower insulator 250-2.

When the first current interruptive device 211-2 or the second current interruptive device 212-2 is operated, the gas generated in the electrode assembly 220 is collected in the first gas storage unit 211-3 and the second gas storage unit 212-3. And, when the upper insulator 250-1 moves upward to a height L1 or higher due to the pressure of the gas collected in the first gas storage unit 211-3 and the second gas storage unit 212-3, the gas collected in the first gas storage unit 211-3 and the second gas storage unit 212-3 may be discharged to the outside.

The first gas storage unit 211-3 may include a first recess part 211-3-1 and a second recess part 211-3-2. The first recess part 211-3-1 may be a space formed by being recessed toward the first upper end cap 211-1. The second recess part 211-3-2 may be a space formed by being recessed toward the upper insulator 250-1. The first gas storage unit 211-3 may be formed between the first recess part 211-3-1, the second recess part 211-3-2, and the first current interruptive device 211-2.

When the upper insulator 250-1 moves upward to the first height L1 or higher, the air collected in the first gas storage unit 211-3 may be discharged to the outside while the second recess part 211-3-2 is exposed to the outside.

The size of the path through which the gas collected in the first gas storage unit 211-3 is discharged may be determined based on the height L3 and the width L2 of the second recess part 211-3-2. In particular, as the width L2 is larger, the gas discharge path may be formed to be larger.

The first contact part 211-5 may be a contact part between the first upper end cap 211-1 and the first current interruptive device 211-2. When the first current interruptive device 211-2 moves upward, the first contact part 211-5 is opened, and the internal gas may be collected in the first gas storage unit 211-3. Here, the first contact part 211-5 being opened means that the first upper end cap 211-1 and the first current interruptive device 211-2 are separated. The internal gas can move through a space generated while the first upper end cap 211-1 and the first current interruptive device 211-2 are separated, thereby being collected in the first gas storage part 211-3.

The second top cap assembly 212 may have the same structure as the first top cap assembly 211. Therefore, details of the second top cap assembly 212 will be omitted.

The second gas storage unit 212-3 may have the same structure as the first gas storage unit 211-3. In addition, the second gas storage unit 212-3 may collect and discharge gas in the same manner as the first gas storage unit 211-3. Therefore, details of the second gas storage unit 212-3 will be omitted.

The first gas storage unit 211-3 and the second gas storage unit 212-3 may contain a fire extinguishing gas. The fire extinguishing gas may be carbon dioxide or nitrogen gas. The fire extinguishing gas may prevent fires caused by runaway that may occur due to an abnormal operation of the cylindrical battery 200.

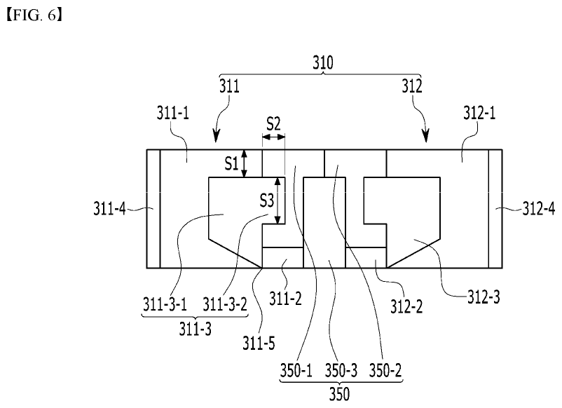

FIG. 6 is a schematic cross-sectional view showing a top cap assembly according to another embodiment of the present disclosure.

Referring to FIG. 6, the top cap assembly 310 may include a first top cap assembly 311 and a second top cap assembly 312. The first top cap assembly 311 and the second top cap assembly 312 may be electrically separated by the insulator 350. The first top cap assembly 311 and the second top cap assembly 312 may be structured so as to be mutually symmetrical with respect to the insulator 350.

The insulator 350 may be formed in a structure extending in the length and width directions of the top cap assembly 310 while passing through the central part of the top cap assembly 310. The insulator 350 may include a first insulator 350-1, a second insulator 350-2 and a lower insulator 350-3.

The first top cap assembly 311 may include a first upper end cap 311-1, a first current interruptive device 311-2, a first gas storage unit 311-3, and a gasket 311-4. The first upper end cap 311-1 may form a positive electrode terminal in a form of being exposed to the outside. The first current interruptive device 311-2 may be formed in the lower part of the first insulator 350-1.

The second top cap assembly 312 may include a second upper end cap 312-1, a second current interruptive device 312-2, a gas storage unit 312-3, and a second gasket 312-4. The second upper cap 312-1 may form a positive electrode terminal in a form of being exposed to the outside. The second current interruptive device 312-2 may be formed in the lower part of the second insulator 350-2.

The first insulator 350-1 may be structured so as to be attached to the first current interruptive device 311-2. Therefore, when the first current interruptive device 311-2 is operated, the first insulator 350-1 may move upward and protrude.

The second insulator 350-2 may be structured so as to be attached to the second current interruptive device 312-2. Therefore, when the second current interruptive device 312-2 is operated, the second insulator 350-2 may move upward and protrude.

The first insulator 350-1 and the second insulator 350-2 may be structured so as to be separated from each other. Therefore, the first insulator 350-1 and the second insulator 350-2 may be separated and operated.

The first current interruptive device 311-2 and the second current interruptive device 312-2 may be structured so as to be electrically separated by a lower insulator 350-3. In addition, the first current interruptive device 311-2 and the second current interruptive device 312-2 do not affect mutual operation.

When the first current interruptive device 311-2 is operated, internal gas may be collected in the first gas storage unit 311-3. And, when the first insulator 350-1 moves upward to the height S1 or higher due to the gas pressure collected in the first gas storage unit 311-3, the gas collected in the first gas storage unit 311-3 may be discharged to the outside.

The first gas storage unit 311-3 may include a first recess part 311-3-1 and a second recess part 311-3-2. The first recess part 311-3-1 may be a space formed by being recessed toward the first upper end cap 311-1. The second recess part 311-3-2 may be a space formed by being recessed toward the first insulator 350-1. The first gas storage unit 311-3 may be formed between the first recess part 311-3-1, the second recess part 311-3-2, and the first current interruptive device 311-2.

When the first insulator 350-1 moves upward to the height S1 or higher, the second recess part 311-3-2 is exposed to the outside, and the air collected in the first gas storage unit 311-3 can be discharged to the outside.

Based on the height S3 and the width S2 of the second recess part 311-3-2, the size of the path through which the gas collected in the first gas storage unit 311-3 is discharged may be determined. In particular, as the width L2 is larger, the gas discharge path may be formed to be larger.

The first contact part 311-5 may be a contact part between the first upper end cap 311-1 and the first current interruptive device 311-2. When the first current interruptive device 311-2 moves upward, the first contact part 311-5 is opened and the discharged gas may be collected in the first gas storage unit 311-3. Here, the first contact part 511-5 being opening means that the first upper end cap 311-1 and the first current interruptive device 311-2 are separated. The internal gas may be moved through a space generated while the first upper cap 311-1 and the first current interruptive device 311-2 are separated, thereby being collected in the first gas storage part 311-3.

The second top cap assembly 312 may have the same structure as the first top cap assembly 311. Therefore, details of the second top tab assembly 312 will be omitted.

The second gas storage unit 312-3 may have the same structure as the first gas storage unit 311-3. In addition, the second gas storage unit 312-3 may collect and discharge gas in the same manner as the first gas storage unit 311-3. Therefore, details of the second gas storage unit 312-3 will be omitted.

The first gas storage unit 311-3 and the second gas storage unit 312-3 may contain a fire extinguishing gas. The fire extinguishing gas may be carbon dioxide or nitrogen gas. The fire extinguishing gas may prevent fires caused by runaway that may occur due to abnormal operation of the cylindrical battery.

When the first insulator 350-1 and the second insulator 350-2 move upward and protrude to the outside, the operator can visually confirm the degree of protrusion of the first insulator 350-1 and the second insulator 350-2. In addition, the degree of generation of internal gas can be grasped through the degree of protrusion of the first insulator 350-1 and the second insulator 350-2.

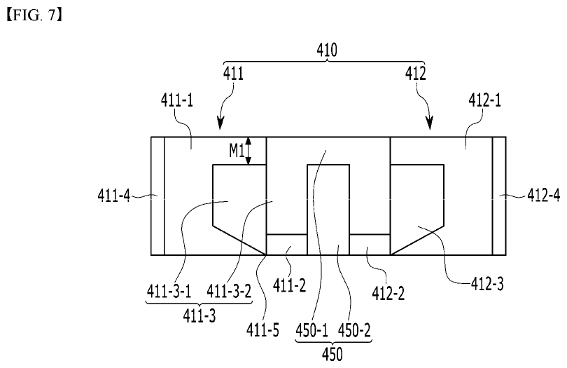

FIG. 7 is a schematic cross-sectional view showing a top cap assembly according to another embodiment of the present disclosure.

Referring to FIG. 7, the top cap assembly 410 may include a first top cap assembly 411 and a second top cap assembly 412. The first top cap assembly 411 and the second top cap assembly 412 may be electrically separated by the insulator 450.

The insulator 450 may be formed in a structure extending in the length and width directions of the top cap assembly 410 while passing through the central part of the top cap assembly 410. The insulator 450 may include an upper insulator 450-1 and a lower insulator 450-2.

The first top cap assembly 411 may include a first top end cap 411-1, a first current interruptive device 411-2, a first gas storage unit 411-3 and a gasket 411-4. The first upper end cap 411-1 may form a positive electrode terminal in a form of being exposed to the outside. The first current interruptive device 411-2 may be formed in the lower part of the upper insulator 450-1.

The second top cap assembly 412 may include a second upper end cap 412-1, a second current interruptive device 412-2, a gas storage unit 412-3, and a second gasket 412-4. The second upper end cap 412-1 may form a positive electrode terminal in a form of being exposed to the outside. The second current interruptive device 412-2 may be formed in the lower part of the upper insulator 450-1.

The upper insulator 450-1 may be structured so as to be attached to the first current interruptive device 411-2 and the second current interruptive device 412-2. Thus, even if any one of the first current interruptive device 411-2 and the second current interruptive device 412-2 is operated, the upper insulator 450-1 may move upward and protrude. For example, when the first current interruptive device 411-2 is operated, the upper insulator 450-1 moves upward and the second current interruptive device 412-attached to the upper insulator 450-1 can also move upward together. In addition, when the second current interruptive device 412-2 is operated, the upper insulator 450-1 moves upward, and the first current interruptive device 411-2 attached to the upper insulator 450-1 can also move upward together.

When the upper insulator 450-1 moves upward and protrudes to the outside, the operator can visually confirm the degree of protrusion of the upper insulator 450-1. Further, the degree of generation of internal gas can be grasped through the degree of protrusion of the upper insulator 450-1.

When the first current interruptive device 411-2 or the second current interruptive device 412-2 is operated, internal gas can be collected in the first gas storage unit 411-3 and the second gas storage unit 412-3. However, contrary to the embodiments described above, according to this embodiment, even if the upper insulator 450-1 moves upward to the second height M1 or higher by the gas pressure collected in the first gas storage unit 411-3 and the second gas storage unit 412-3, the gas collected in the first gas storage unit 411-3 and the second gas storage unit 412-3 is not discharged to the outside. However, when excessive gas is generated due to heating or the like from the outside and the current interruptive devices 411-2 and 412-2 exceed the second height M1, the upper insulator 450-1 and the current interruptive devices 411-2 and 412-2 are discharged to the outside together, and internal gas can be discharged to the outside.

The first gas storage unit 411-3 may be a space formed by being recessed toward the first upper end cap 411-1. The first gas storage unit 411-3 may be formed between the first upper end cap 411-1, the upper insulator 450-1 and the first current interruptive device 411-2.

The first contact part 411-5 may be a contact part between the first upper end cap 411-1 and the first current interruptive device 411-2. When the first current interruptive device 411-2 moves upward, the first contact part 411-5 is opened and the internal gas may be collected in the first gas storage unit 411-3. Here, the first contact part 411-5 being opened means that the first upper end cap 411-1 and the first current interruptive device 411-2 are separated. The internal gas may be moved through a space generated when the first upper end cap 411-1 and the first current interruptive device 411-2 are separated, thereby being collected in the first gas storage unit 411-3.

The second top cap assembly 412 may have the same structure as the first top cap assembly 411. Therefore, details of the structure of the second top tab assembly 412 will be omitted.

The second gas storage unit 412-3 may have the same structure as the first gas storage unit 411-3. In addition, the second gas storage unit 412-3 may collect and discharge gas in the same manner as the first gas storage unit 411-3. Therefore, details of the second gas storage unit 412-3 will be omitted.

The first gas storage unit 411-3 and the second gas storage unit 412-3 may contain a fire extinguishing gas. The fire extinguishing gas may be carbon dioxide or nitrogen gas. The fire extinguishing gas may prevent fires caused by runaway that may occur due to abnormal operation of the cylindrical battery.

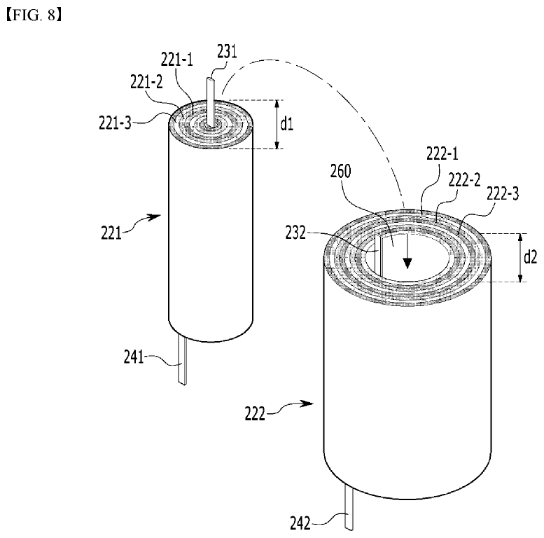

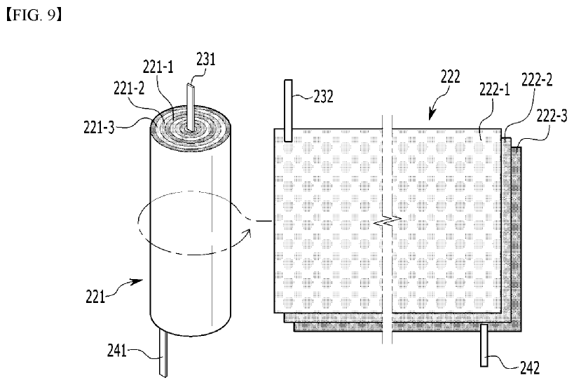

FIG. 8 is a schematic view showing that the electrode assembly of FIG. 2 is manufactured according to an embodiment of the present disclosure. FIG. 9 is a schematic diagram showing that the electrode assembly of FIG. 2 is manufactured according to another embodiment of the present disclosure.

Referring to FIGS. 2, 8, and 9, the electrode assembly 220 may include a first electrode assembly 221 and a second electrode assembly 222. The first electrode assembly 221 may be located in the central part of the second electrode assembly 222.

The first electrode assembly 221 may have a structure in which a first positive electrode 221-1, a first separator 221-2, and a first negative electrode 221-3 are wound in a sequence. A first positive electrode tab 231 can formed in the upper part of the first electrode assembly 221 to be electrically connected to the first top cap assembly 211. A first negative electrode tab 241 is formed in the lower part of the first electrode assembly 221 to be electrically connected to the battery case.

The second electrode assembly 222 may have a structure in which a second positive electrode 222-1, a second separator 222-2, and a second negative electrode 222-3 are wound in a sequence. A second positive electrode tab 232 is formed in the upper part of the second electrode assembly 222 to be electrically connected to the second top cap assembly 212. A second negative electrode tab 242 may be formed in the lower part of the second electrode assembly 222 to be electrically connected to the battery case.

In the first electrode assembly 221, the first negative electrode 221-3 may include a negative active material. In the second electrode assembly 222, the second negative electrode 222-3 may include a negative active material. The content of silicon (Si) in the first negative electrode 221-3 may be 25% to 75% relative to the content of silicon in the second negative electrode 222-3. The loading amount of the negative active material of the first negative electrode 221-3 may be 40% to 70% relative to the loading amount of the negative active material of the second negative electrode 222-3.

With such a structure, it is possible to prevent the structure of the electrode assembly 220 from being deformed due to volume expansion and heat generation of the first negative electrode 221-3 and the second negative electrode 222-3 during the charging/discharging process of the cylindrical battery 200.

The electrode assembly 220 may be manufactured by various methods. As an example, the electrode assembly can be manufactured by winding the first electrode assembly 221 and the second electrode assembly 222, respectively, or alternatively can be manufactured by inserting the first electrode assembly 221 into the central part 260 of the second electrode assembly 222. The first electrode assembly 221 may be manufactured by winding a stack of the first positive electrode 221-1, the first separator 221-2, and the first negative electrode 221-3. The second electrode assembly 222 may be manufactured by winding a stack of the second positive electrode 222-1, the second separator 222-2, and the second negative electrode 222-3. At this time, the second electrode assembly 222 may wind the second electrode assembly 222 using a mandrel (not shown) equal to the diameter d2 of the central part 260. In addition, the diameter d2 of the central part 260 may be equal to the diameter d1 of the first electrode assembly 221.

The electrode assembly 220 can be manufactured by a process including first manufacturing the first electrode assembly 221, and then winding a stack of the second negative electrode 222-1, the second separator 222-2 and the second negative electrode 222-3 by using the first electrode assembly 221 as a mandrel.

The cylindrical battery according to the embodiments of the present disclosure includes electrically separated electrode assemblies and top cap assemblies in one structure, so that the deformation of the electrode assemblies occurring in the charging/discharging process can be minimized. In particular, it is possible to prevent stress from being concentrated in the central part of the electrode assemblies.

In addition, each electrode assembly can be controlled by electrically separated top cap assemblies, thereby providing a system capable of rapidly discharging the thermal energy generated inside.

Based on the above disclosure, this is to be understood by those of ordinary skill in the art that various applications and modifications can be made without departing from the scope of the present disclosure.

1. A cylindrical battery comprising a plurality of electrode assemblies, and a plurality of top cap assemblies located on an upper part of the plurality of electrode assemblies,
wherein the plurality of top cap assemblies are electrically separated from each other by an insulator.

2. The cylindrical battery according to claim 1,
wherein the plurality of top cap assemblies comprises:
a first top cap assembly having a first upper end cap, a first current interruptive device, and a first gas storage; and
a second top cap assembly having a second upper end cap, a second current interruptive device, and a second gas storage.

3. The cylindrical battery according to claim 2,
wherein the insulator comprises an upper insulator and a lower insulator.

4. The cylindrical battery according to claim 3,
wherein the upper insulator has a “Π”-shaped cross-sectional shape.

5. The cylindrical battery according to claim 4,
wherein the upper insulator receives an intermediate part of the lower insulator.

6. The cylindrical battery according to claim 3,
wherein the lower insulator is located between the first current interruptive device and the second current interruptive device, and electrically insulates the first current interruptive device and the second current interruptive device.

7. The cylindrical battery according to claim 3,
wherein the upper insulator is attached to the first current interruptive device and the second current interruptive device.

8. The cylindrical battery according to claim 7,
wherein if any one of the first current interruptive device or the second current interruptive device is operated, the upper insulator moves upward and protrudes beyond the plurality of top cap assemblies.

9. The cylindrical battery according to claim 7,
wherein, when the first current interruptive device or the second current interruptive device is operated, gas generated in the electrode assembly is collected in the first gas storage and the second gas storage.

10. The cylindrical battery according to claim 9,
wherein, when the upper insulator moves upward a predetermined height or higher due to the pressure of the gas collected in the first gas storage and the second gas storage, the gas collected in the first gas storage and the second gas storage is discharged outside the plurality of top cap assemblies.

11. The cylindrical battery according to claim 2,
wherein the insulator comprises a first insulator, a second insulator, and a lower insulator.

12. The cylindrical battery according to claim 11,
wherein the first insulator and the second insulator are independent of each other.

13. The cylindrical battery according to claim 12,
wherein the first insulator is attached to the first current interruptive device, and when the first current interruptive device is operated, the first insulator moves upward and protrudes beyond the plurality of top cap assemblies.

14. The cylindrical battery according to claim 12,
wherein the second insulator is attached to the second current interruptive device, and when the second current interruptive device is operated, the second insulator moves upward and protrudes beyond the plurality of top cap assemblies.

15. The cylindrical battery according to claim 2,
wherein the plurality of electrode assemblies comprises a first electrode assembly and a second electrode assembly, and the first electrode assembly is located in a central part of the second electrode assembly.

16. The cylindrical battery according to claim 15,
wherein a first positive electrode tab of the first electrode assembly is electrically connected to the first top cap assembly, and a second positive electrode tab of the second electrode assembly is electrically connected to the second top cap assembly.

17. A method for manufacturing a cylindrical battery comprising the steps of:
winding a first positive electrode, a first separator, and a first negative electrode to manufacture a first electrode assembly having a central part;
winding a second positive electrode, a second separator, and a second negative electrode to manufacture a second electrode assembly;
inserting the first electrode assembly into the central part of the second electrode assembly;
electrically connecting a first positive electrode tab of the first electrode assembly to a first top cap assembly; and
electrically connecting a second positive electrode tab of the second electrode assembly to a second top cap assembly.

18. A method for manufacturing a cylindrical battery comprising the steps of:
winding a first positive electrode, a first separator, and a first negative electrode to manufacture a first electrode assembly;
winding a stack of a second positive electrode, a second separator, and a second negative electrode using the first electrode assembly as a mandrel to manufacture a second electrode assembly such that the first electrode assembly is located in a central part of the second electrode assembly;
electrically connecting a first positive electrode tab of the first electrode assembly to a first top cap assembly; and
electrically connecting a second positive electrode tab of the second electrode assembly to a second top cap assembly.
